(19) United States
(12) Patent Application Publication
(10) Pub. No.: US 2010/0293055 A1
(43) Pub. Date: Nov. 18, 2010

(54) System for dynamically generating affiliate advertising within electronic communications

(76) Inventor: Anthony Nash, Beckenham (GB)

Correspondence Address: BRETT J. TROUT, PC, 516 WALNUT, DES MOINES, IA, 50309, US

(21) Appl. No.: 12/454,203

(22) Filed: May 14, 2009

(51) Int. Cl. G06Q 30/00

(52) U.S. Cl. 705/14.55; 705/14.69; 705/14.73; 705/27

(57) ABSTRACT

A system and method with a distributor physically acting upon a computer to send an electronic communication to a recipient. The system delivers dynamic content to the recipient's electronic communication based on the distributor's preferences using identifiers in static code placed within the body of the electronic communication. Cookies sent by the system to the recipient define the content and enable dynamic redirects to websites from hyperlinks from this content.

### TECHNICAL FIELD

The present disclosure relates in general to the association of advertisements with electronic communications and, more particularly, to the dynamic generation of advertisements within electronic communications upon opening of the electronic communication.

### BACKGROUND

Electronic communications such as email have been used for many years to deliver advertising messages to consumers. As most such advertisements are unrelated to the consumer's needs, a large number of electronic mail advertisements must be sent to obtain a single positive response. Consumers therefore receive thousands of useless advertisements for every one of interest. In response, consumers have adopted systems for filtering such useless advertising messages. Most advertising electronic mail messages are filtered from trusted senders and discarded before ever reaching their intended recipient.

Affiliate marketing programs are also known in the art. Such programs typically pay affiliates a commission, based upon a recipient clicking on a hyperlink to a commercial website and making a purchase or performing some other defined action on such a website. While such affiliate marketing programs are well known and generate a substantial amount of income, one drawback associated with such programs is that the advertising presented to the potential customer is not tailored to their needs or interests. Accordingly, even if a large number of potential customers visit the website, only a small fraction actually perform a commission rewarded action and generate income for the affiliate.

Another drawback of affiliate marketing programs is that if the advertisement is not tailored to the potential customer's needs, the affiliate hyperlink appears to be obtrusive advertising, undermining the overall experience of the affiliate's website, as opposed to a specifically tailored advertisement which would increase the website experience for the potential customer.

Yet another drawback associated with prior art affiliate marketing programs is that the affiliate often has little control over the advertising being forwarded. Random advertisements are less likely to generate a favorable response, increasing the need for a larger recipient pool, decreasing revenue and upsetting recipients not interested in receiving such advertisements. If instead, the affiliates were allowed to select the type of advertisements most likely to generate a positive recipient response, this would not only decrease the necessary size of the recipient pool, but it would increase revenue for both the advertiser and the affiliate, and reduce the likelihood that a recipient would find the advertisement intrusive.

It would, therefore, be desirable to combine the best attributes of electronic mail advertising and affiliate marketing advertising with advertisements more specifically tailored to the interests of the targeted recipients. The difficulties encountered in the prior art heretofore are substantially eliminated by the present disclosure.

### SUMMARY OF THE DISLCOSED SUBJECT MATTER

The disclosed subject matter relates to an electronic communication system connecting a server, distributor and recipient across a network such as the Internet. The distributor prepares an electronic communication, such as an email, having an address field, a message field and a signature field. The distributor selects categories of advertisements which the distributor wishes to appear in the signature field area of distributor's email. Once selected, the advertisements are associated within the server with the distributor as part of an affiliate marketing program. The distributor downloads and inserts a piece of software code, which may be HTML, into the signature field of distributor's email client software so that emails sent from distributor's client software will then contain this HTML.

When the recipient receives and opens an email from the distributor, the HTML generates a request to the server to return a predetermined advertisement, selected from the categories chosen by the distributor, to display within the email. If the recipient allows cookies, the server returns the predetermined advertisement from the website and sets a cookie on the recipient's computer. This cookie denotes which advertisement was returned. If the recipient does not allow cookies, the server returns a default advertisement.

In the event the recipient clicks on a hyperlink associated with the advertisement, the server identifies the distributor from a unique identification parameter of the URL associated with the hyperlink and identifies the advertisement from a unique advertisement identification parameter in the returned cookie. The server then determines which advertiser's website to redirect the recipient to, and, by means of setting a new cookie on the recipient's computer or query string parameters in the advertiser's URL, the recipient's activity can be identified on the advertiser's website.

If the recipient makes a purchase or performs some other predetermined action on the advertiser's website, the server may use the identification parameters of the query string or cookie to compensate the distributor for that predetermined action.

### BRIEF DESCRIPTION OF THE DRAWINGS

The present disclosure will now be described, by way of example, with reference to the accompanying drawings in which:

FIG. 1 illustrates a system embodying the subject matter of the disclosure;

FIG. 2 illustrates an exemplary email incorporating HTML code within the signature field;

FIG. 3 illustrates a flow chart of a process for dynamically generating an advertising image in an electronic communication;

FIG. 4 illustrates an exemplary email received by a recipient and displaying the dynamically generated advertisement;

FIG. 5 illustrates a flow chart of a process for redirecting a recipient to an advertiser's website if that recipient clicks on a received advertisement.

### DETAILED DESCRIPTION OF THE DRAWINGS

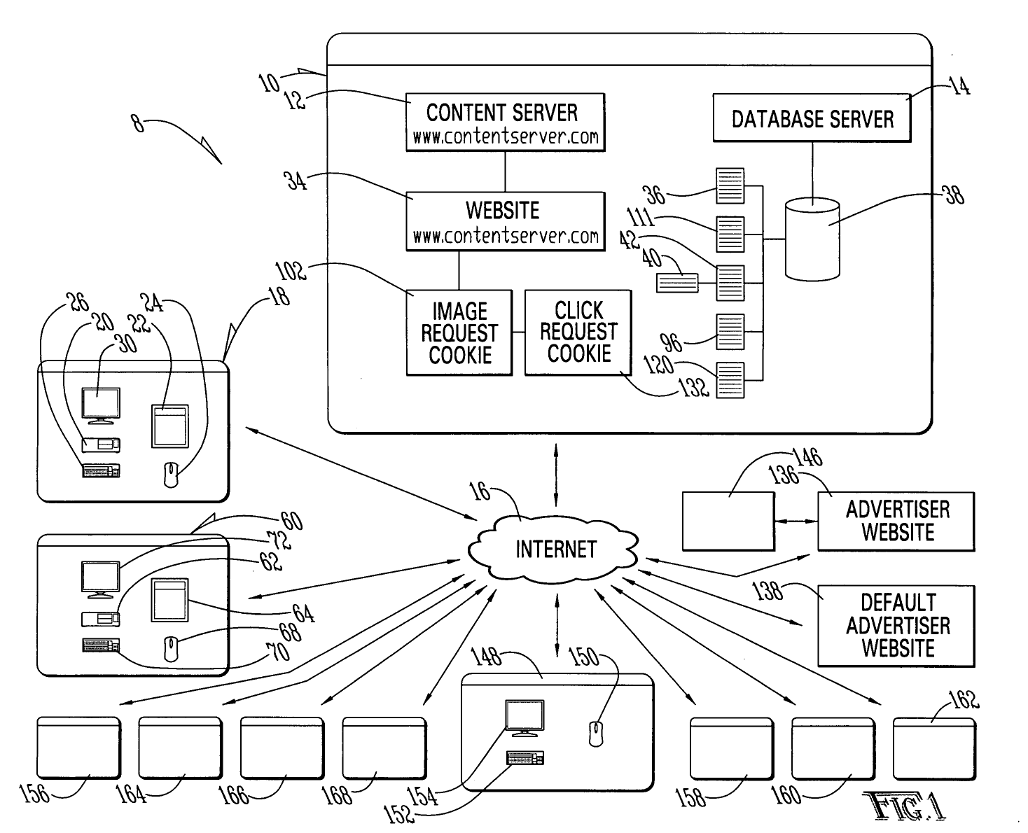

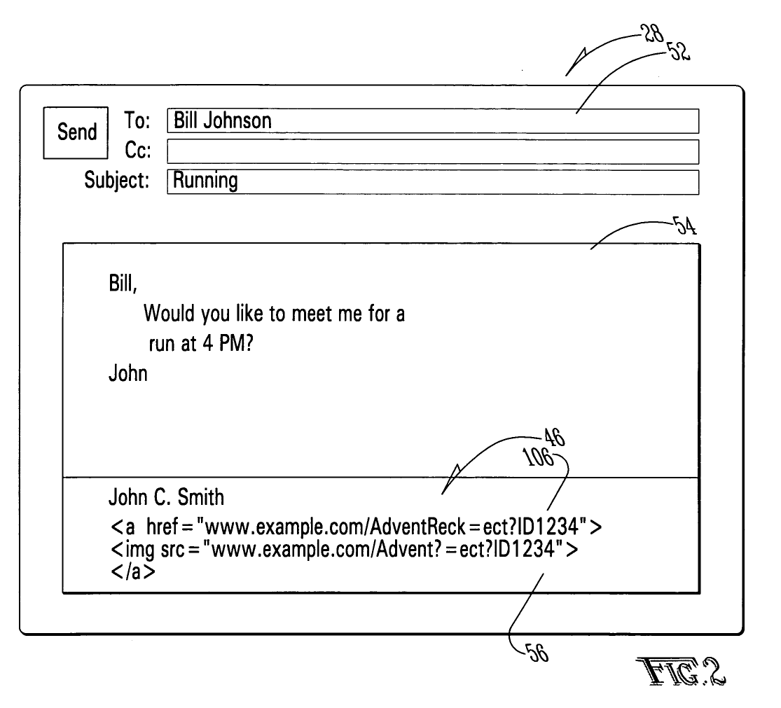

The present subject matter relating to a system and method for dynamically generating affiliate marketing advertisements within electronic communications is shown generally as a networked system (8) in FIG. 1. The networked system (8) includes a server system (10), which itself includes content servers (12) and database servers (14) coupled to a network which, in the preferred embodiment, is the Internet (16). The servers (12) and (14) may be of any type known in the art, and may have both internal and external storage mechanisms to manipulate information and to process information.

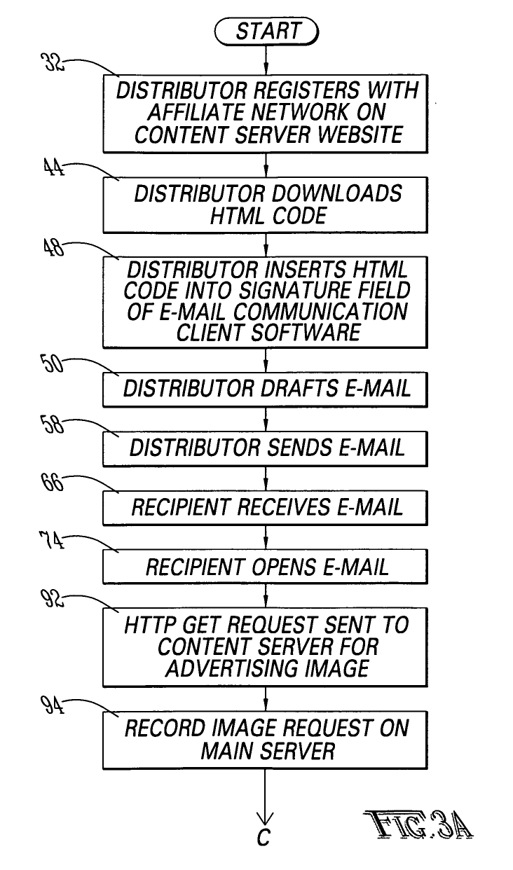

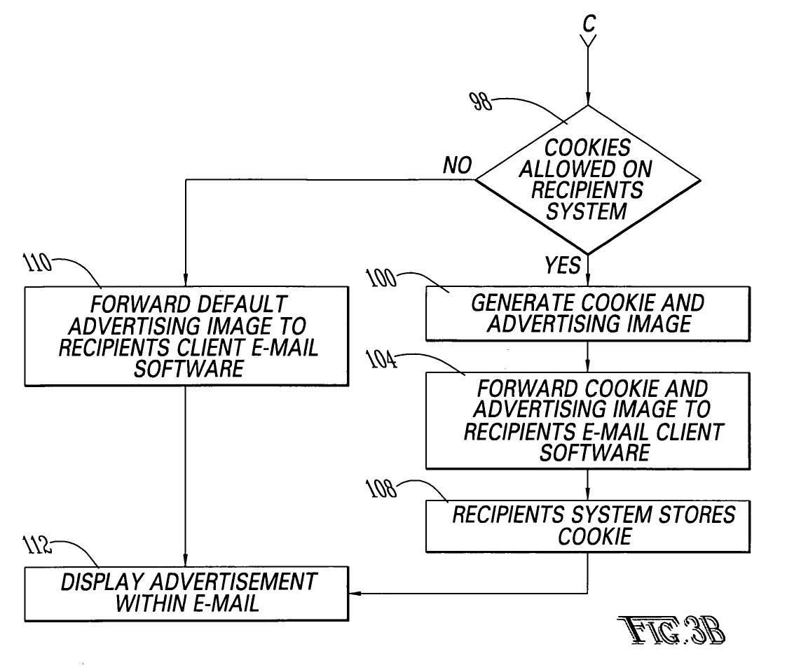

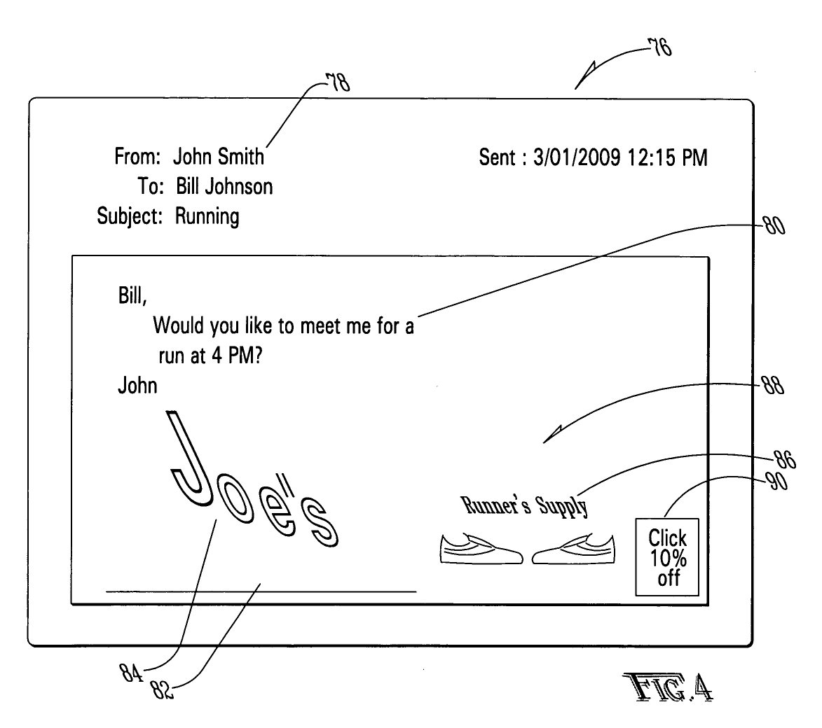

When it is desired to utilize the system of the present disclosure, a distributor, preferably a person (not shown) utilizes a distributor computer system (18), such as a personal computer utilizing a central processing unit (20). The distributor computer system (18) includes an electronic mail client software application (22), such as Outlook, Gmail, or any other electronic mail client software application such as those known in the art. The distributor physically manipulates an input device such as a mouse (24) and/or a keyboard (26) to actuate the email application (22) to display a form electronic communication (28), such as an email, on a display, such as a monitor (30). (FIGS. 1-2) As shown in FIGS. 2 and 3, in Step 32 of the process for dynamically generating an advertisement, the distributor first registers with the affiliate marketing program through a website (34) associated with, and preferably hosted on, the content server (12). Information input on the website (34) by the distributor is stored in a table (36) of a database (38) on the database server (14). The distributor then selects advertisements (40) from a table (42) of advertisements (40) in the database (38) of the database server (14). The distributor then downloads (44) a unique and personalized distributor code from the content server (12) via the Internet (16). The distributor code may be a piece of HTML code (46) which the content server (12) associates with the distributor. (FIGS. 1-3). The distributor may insert (48) the HTML code (46) into each email (28) separately or may set up the distributor's email client application (22) to automatically insert the HTML code (46) into all outgoing electronic mail (28) by using the email client application's signature functionality.

The distributor may then draft (50) email (28) to recipients. The email (28) includes an address field (52), message area (54), and a signature area (56). The HTML code (46) is located within the signature area (56), but may be associated with any portion of the email (28). The distributor drafts (50) the email (28) and sends (58) the email (28) to recipients in a manner such as that known in the art. The HTML code (46) may be automatically appended to the email (28) as described above or manually appended to the email (28) such that it may be rendered in the signature area (56) on opening. In the preferred embodiment, the HTML code (46) will be of the form below;

<a href=″http://www.contentserver.com/click/bobjenkins1234″>
<img alt=”A message from www.contentserver.com chosen by
Bob Jenkins”
src=″http://www.contentserver.com/advert/bobjenkins1234″>
</a>

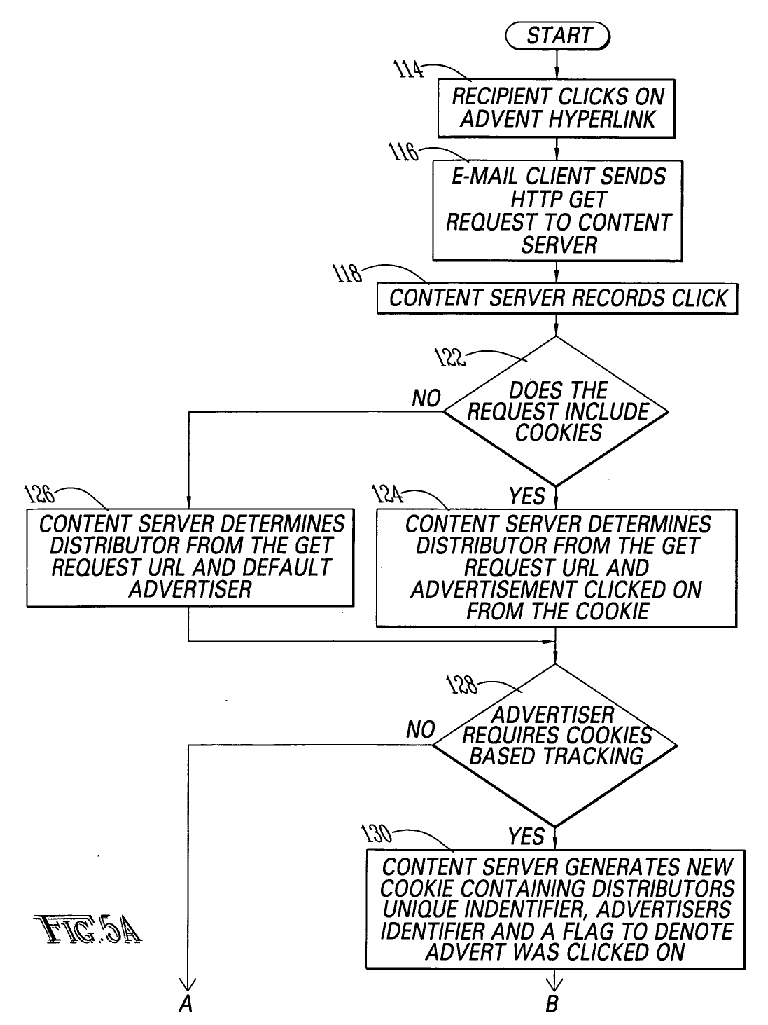

The electronic mail (28) moves from the distributor's computer system (18) through the Internet (16) using standard electronic mail transfer mechanisms to a recipient's computer system (60). In the preferred embodiment a recipient, preferably a person (not shown), utilizes a computer system (60), such as a personal computer including a central processing unit (62) and an electronic mail client application (64), to receive (66) the email (28). The recipient then physically manipulates a peripheral such as a mouse (68) or keyboard (70) to display the electronic mail client application (64) on a display, such as a monitor (72) and to cause the email client application (64) to open (74) the email (28) in a manner such as that well known in the art. As shown in FIG. 4, the received and displayed email (76) includes the address field (78), message area (80) and signature area (82). The signature area (82), if the client software permits, displays media, such as an image (84) and text (86) associated with the advertisement (88) and sets the hyperlink (90) for this image (84) produced by the HTML code (46).

Upon opening the electronic mail (28), the electronic mail client application (64) parses the HTML code (46) and generates (92) an HTTP GET request to the content server (12) for the advertisement (88). The advertisement may include multimedia content, such as audio, video, slideshow photographs, images (84) or text (86). The content server (12) records (94) this request in a table (96) of database (38) on a database server (14).

As shown in Step 98, in the event the recipient computer system (60) allows cookies to be set on the system (60), the process moves to Step 100, where the content server (12) generates a recipient code, such as a cookie (102), and then forwards (104) the advertisement (88), formed of an image (84), text (86) or other media and the cookie (102) to the recipient computer system (60). The content server (12) accomplishes these steps by determining the distributor from a distributor code, such as a unique identification parameter (106) of the URL of the originating image HTTP GET request associated with the distributor, and selecting, an advertisement by a predetermined algorithm such as those known in the art from the preselected advertiser categories selected by the distributor as described above. The content server (12) generates (100) the cookie (102) containing the advertisement's (88) unique identification, the distributor's unique identification (106) and a timestamp (not shown). The recipient's computer system (60) thereafter stores (108) the cookie (102) on this system (60) and displays the received email (76) on the monitor (72) as shown in FIG. 4.

In the event the recipient's computer system (60) does not accept cookies, the process moves from Step 98 to Step 110, where, upon opening (74) the email (28), the HTML code (46) generates (92) a HTTP GET request for the advertisement (88) media to the content server (12), which identifies the recipient computer system (60) as not accepting cookies. Since a cookie cannot be accepted by the recipient's computer system (60), the content server (12) forwards (110) default advertising media defined in a table (111) in a database (38) on the database server (14) to the recipient computer system (60) where it is displayed (112) on the monitor (72) when the email (28) is opened.

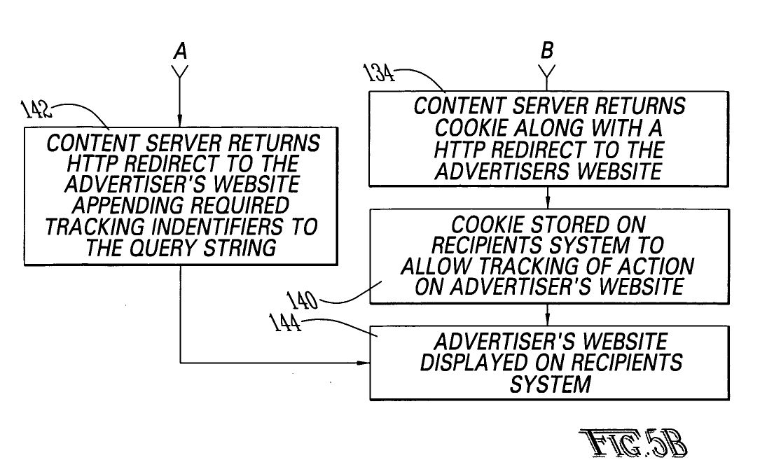

Once the advertisement (88) has been displayed (112) on the monitor (72), the recipient has the option, as shown in FIG. 5, of physically manipulating the mouse (68) or keyboard (70) to physically click (114) or otherwise select the hyperlink (90) associated with the advertisement (88). In response to the click (114), an anchor tag of the hyperlink (90) directs the recipient's electronic mail client application (64) to send (116) a HTTP GET request to the content server (12). The content server records (118) this click in a table (120) of database (38) on the database server (14).

If the GET request contains the originating cookie (102), then the content server (12) will determine (124) the identity of the distributor from the associated URL associated with the GET request and selects the appropriate advertiser (not shown) from the advertisement (88) clicked on, as indicated by the information contained within the cookie (102). If the GET request does not contain the originating cookie (102) then the content server (12) still determines the identity of the distributor from the associated URL associated with the GET request, but selects the appropriate advertiser from a preselected group of default advertisers.

The content server (12) then determines (128) if the selected advertiser requires cookie-based tracking. If the advertiser does require cookie-based tracking, the content server (12) generates (130) a new cookie (132) containing the advertisement's (88) unique identification, the distributor's unique identification, a timestamp and a flag to denote a predetermined action had been taken regarding the advertisement (88), such as the particular advertising image (84) being clicked on.

The content server (12) then returns (134) the cookie (132) to the recipient's system (60) across the Internet (16) along with a HTTP redirect to the selected advertiser's website associated with the advertisement (88). If the recipient's system accepts cookies, the recipient's computer system (60) then stores (140) the cookie (132) on recipient's computer system (60).

Alternatively, if the content server (12) determines (128) the advertiser does not require cookie-based tracking, the content server (12) simply returns (142) to the recipient's system (60) across the Internet (16) an HTTP redirect to the selected advertiser's website (136) or (138), along with URL query string parameters which contain an identifier for the originating server system (10) and the distributor. Whether the advertiser requires cookie-based tracking or URL query string parameters is determined by the advertiser during advertiser's setup and registration with the server system (10). Upon receipt of the HTTP redirect, the recipient's computer system (60) displays (144) the website (136) or (138) on the display (72) associated with the recipient's computer system (60).

The use of the cookie (132) or URL query string enables the distributor to be identified as the sender of the advertisement (88) which prompted the recipient to click on the advertisement (88). Standard affiliate marketing techniques such as those known in the art are used to track the recipient's actions in association with the advertiser's website (136). Preferably, the website (136) presents the recipient with an opportunity to perform a supplemental predetermined action in association with the advertiser's website (136), such as a purchase of goods or services. In the event the recipient performs such an action on the advertiser's website (136), a server (146) associated with the advertiser's website (136) informs the server system (10) across the Internet (16) that this action has been performed. If the distributor is identified by the server (146) the server system (10) initiates payment to the distributor subject to a contract or other predetermined agreement between the operator of the server system (10) and the distributor. In the event the distributor cannot be identified, no payment is made.

Unlike prior art systems involving an advertiser hiring a marketing company to randomly send out bulk electronic mail messages to unknown recipients on a purchased list, the present disclosure allows the advertiser to target advertisements not only to a specific audience, but to provide the potential customer a frame of reference for the advertisement in the form of a referral from the distributor who has a pre-existing relationship with the potential customer. The distributor may send the email (28) to a first recipient computer system (60) and later send the same or different email (28) to a second recipient computer system (148) across the internet (16) to allow the second recipient to utilize a mouse (150) or keyboard (152) to open the email (28) and display the email (28) on the second recipient's display (154) in a manner such as that described above.

A second distributor (not shown) may utilize a second distributor computer system (156) to access the content server (12), retrieve the fragment of HTML code (46) from the content server (12), and insert the fragment of HTML code (46) into the signature area (56) of the email (28). The second distributor may send messages to various email recipients in a manner such as that described above. The second distributor may use the second distributor computer system (156) to send the email (28) to the recipient computer systems (60), (148), or any other recipient computer systems, such as (158), (160) and (162). Any additional number of distributors may use any additional number of distributor computer systems (164), (166) and (168) and may all utilize the same server system (10) or different systems (not shown). In the preferred embodiment, there are at least one hundred, preferably at least one thousand and, most preferably, at least ten thousand simultaneous distributor systems operating to distribute the advertisements associated with the content server (12) and preferably at least one thousand, more preferably at least ten thousand and, most preferably, at least one hundred thousand recipient systems receiving email (28) incorporating the advertisements (88) associated with the content server (12). Of course, as known in the prior art, the content server (12) and database server (14) may either be single servers or may be a series of servers utilized to accomplish the functionality described above.

Although the subject matter disclosed has been described with respect to a preferred embodiment thereof, it is to be understood that it is not to be so limited since changes and modifications can be made therein which are within the full, intended scope of this disclosure as defined by the appended claims.

What is claimed is:

1. An electronic communication advertising system comprising:
(a) a distributor computer system;
(b) a distributor associated with said distributor computer system;
(c) a recipient computer system;
(d) a recipient associated with said distributor computer system;
(e) a display associated with said recipient computer system;
(f) a server computer system;
(g) a network connected to said distributor computer system, said recipient computer system and said server computer system;
(h) a distributor code associated with said distributor;
(i) wherein said server computer system is configured to associate an advertisement with said distributor code;
(j) an electronic communication;
(k) wherein said distributor computer system is configured to associate said distributor code with said electronic communication;
(l) wherein said recipient computer system is configured to receive said electronic communication from said distributor computer system across said network in response to a send instruction from said distributor computer system;
(m) wherein said server computer system is configured to generate a recipient code in response to said recipient computer system sending a request to said server computer system for said advertisement on opening of said electronic communication;
(n) wherein said recipient code is associated with said distributor and said advertisement;
(o) wherein said recipient computer system is configured to receive said recipient code and said advertisement from said server computer system across said network in response to a server instruction from said server computer;
(p) wherein said server computer is configured to generate a website redirect in response to said recipient computer system performing a predetermined action associated with said advertisement;
(q) wherein said recipient computer system is configured to receive said website redirect from said server computer system across said network in response to a redirect instruction from said server computer system; and
(r) wherein said recipient computer system is configured to display on said display a website associated with said website redirect on said recipient computer system after receipt of said website redirect from said server computer system.

2. The electronic communication advertising system of claim 1, wherein said network is a global communications network.

3. The electronic communication advertising system of claim 1, wherein said electronic communication is an electronic mail message.

4. The electronic communication advertising system of claim 3, wherein said distributor computer system is configured to associate said distributor code with a signature field of said electronic communication;

5. The electronic communication advertising system of claim 4, wherein said distributor code is HTML code.

6. The electronic communication advertising system of claim 5, wherein said recipient code is a cookie.

7. The electronic communication advertising system of claim 6, wherein said cookie is associated with said advertisement, said distributor, a timestamp and identification of said predetermined action.

8. The electronic communication advertising system of claim 1, wherein said server computer is configured to identify when recipient has performed a supplemental predetermined action in association with said website.

9. The electronic communication advertising system of claim 8, wherein said server computer is configured to authorize a payment to distributor in response to identification of performance by said recipient of said supplemental predetermined action in association with said website.

10. The electronic communication advertising system of claim 1, wherein said advertising comprises multimedia content.

11. The electronic communication advertising system of claim 1, wherein said advertising comprises an image.

12. The electronic communication advertising system of claim 1, wherein said server computer system is configured to dynamically generate a recipient code after, and in response to said recipient computer system sending a request to said server computer system for said advertisement on opening of said electronic communication;

13. A method for dynamically generating electronic communication content comprising:
(a) providing a distributor computer system;
(b) associating a distributor with said distributor computer system;
(c) providing a recipient computer system;
(d) associating a recipient with said distributor computer system;
(e) associating a display with said recipient computer system;
(f) providing a server computer system;
(g) connecting a network with said distributor computer system, said recipient computer system and said server computer system;
(h) associating a distributor code with said distributor;
(i) associating an advertisement with said distributor code;
(j) providing an electronic communication;
(k) associating said distributor code with said electronic communication on said distributor computer system;
(l) sending said electronic communication from said distributor computer system across said network to said recipient computer system;
(m) opening said electronic communication on said recipient computer system;
(n) sending a request from said recipient computer system to said server computer system across said network after said electronic communication has been opened;
(o) generating a recipient code on said server computer system in response to receipt of said request;
(p) associating said recipient code with said distributor and said advertisement;
(q) sending said recipient code and said advertisement from said server computer system to said recipient computer system across said network;
(r) performing a predetermined action associated with said electronic communication on said recipient computer system;
(s) sending a confirmation from said recipient computer system to said server computer system across said network that said predetermined action has been performed;
(t) generating a website redirect on said server computer system in response to receipt of said confirmation;
(u) associating said website redirect with a website;
(v) sending said website redirect from said server computer system to said recipient computer system across said network; and
(w) displaying said website on said display.

14. The method for dynamically generating electronic communication content of claim 13 further comprising performing a supplemental predetermined action on said recipient computer system wherein said supplemental predetermined action is associated with said recipient.

15. The method for dynamically generating electronic communication content of claim 14 further comprising sending a third confirmation to said server computer system across said network that said supplemental predetermined action has been performed.

16. The method for dynamically generating electronic communication content of claim 15 further comprising forwarding payment to said distributor in response to receipt of said third confirmation.

17. An electronic communication advertising system comprising:
(a) a distributor computer system;
(b) a distributor associated with said distributor computer system;
(c) a recipient computer system;
(d) a recipient associated with said distributor computer system;
(e) a display associated with said recipient computer system;
(f) a server computer system;
(g) a network connected to said distributor computer system, said recipient computer system and said server computer system;
(h) an electronic communication comprising:
(i) an address field;
(ii) a message area; and
(iii) an advertising area;
(i) wherein distributor computer system is configured to deliver said electronic communication to said recipient computer system across said network;
(j) wherein said server computer system is configured to dynamically generate and deliver an advertisement to said recipient computer system in response to said recipient computer system sending a request to said server computer system for said advertisement on opening of said electronic communication;
(k) wherein said server computer system is configured to record a predetermined action performed by said recipient computer system in relation to said advertisement;
(l) wherein said server computer system is configured to make a payment in response to recordation of said predetermined action.

18. The electronic communication advertising system of claim 17, wherein said electronic communication further comprises a signature area and wherein said advertising area is located within said signature area.

19. The electronic communication advertising system of claim 17, wherein said advertising comprises multimedia content.

20. The electronic communication advertising system of claim 17, wherein said advertising comprises an image.
